(19) United States
(12) Patent Application Publication
(10) Pub. No.: US 2021/0009807 A1
(43) Pub. Date: Jan. 14, 2021

(54) Nylon Composition For Improved Sublimation

(71) Applicant: Cristian Pandolfi, Verona (IT)

(72) Inventor: Cristian Pandolfi, Verona (IT)

(21) Appl. No.: 17/031,401

(22) Filed: Sep. 24, 2020

Related U.S. Application Data
(62) Division of application No. 16/159,101, filed on Oct. 12, 2018.

(51) Int. Cl. C08L 77/06; C08K 5/3472; C08K 5/07; C08K 5/00; C08K 3/013; B41M 5/035; C08K 5/5317

(52) U.S. Cl. CPC C08L 77/06; C08K 5/3472; C08K 5/07; C08K 5/0041; B41M 5/0356; B41M 5/0358; B41M 5/0355; C08K 5/5317; C08K 3/013

(57) ABSTRACT

A sublimated polymer composition with improved weatherability having a coating applied to a substrate by a sublimation process. The substrate includes about 60-90% by weight of polymer selected from the group consisting of polyamides, polyester, polyether and combinations thereof; UV absorber; UV inhibitor; pigment, and antioxidant.

### FIELD OF THE INVENTION

The present invention generally relates to a polymer composition having improved UV protection and suitable for sublimation and dying processes. The polymer composition comprises a polyamide, polyester or polyether polymer, pigment, UV inhibitor, UV absorber, antioxidants and, optionally, additional additives. Preferably the composition is in the form of pellets that can be molded into various objects for outdoor applications.

### BACKGROUND OF THE INVENTION

Dye sublimation is a process that uses heat to transfer dye onto materials such as plastic, card, paper, or fabric. Heat and pressure are applied to a solid, turning it into gas through an endothermic reaction without passing through the liquid phase. Sublimation printing processes work well with nylon, polyester and polymer-coated substrates.

In sublimation printing, unique sublimation dyes are transferred to sheets of “transfer” paper via liquid gel ink through a piezoelectric print head or by rotogravure techniques. The ink is deposited on these high-release inkjet papers, which are used for the next step of the sublimation printing process. After the digital design is printed onto sublimation transfer sheets, it is placed on a heat press along with the substrate to be sublimated.

In order to transfer the image from the paper to the substrate, it requires a heat press process that is a combination of time, temperature and pressure. A heat press applies this special combination, which can change depending on the substrate, to “transfer” the sublimation dyes at the molecular level into the substrate. The most common dyes used for sublimation activate at 350 degrees Fahrenheit. However, a range of 380 to 420 degrees Fahrenheit, or 180 to 220 degrees Celsius, is normally recommended for optimal color.

The end result of the sublimation process is a nearly permanent, high resolution, full color print. Because the molecules of sublimation pigments are transforming in gas inside the polymer layer and then becoming solid again, rather than applied at a topical level (such as with screen printing and direct to garment printing), the prints will not crack, fade or peel from the substrate under normal conditions.

For these reasons, it is desirable to use sublimation to apply designs onto objects and articles for outdoor use. Many outdoor products, such as lawn chairs, tables, decking, and toys, are made of hard plastics. These polymer-based products are made from polymers such as thermoplastic and thermosetting polymers by known techniques such as injection molding, profile extrusion, rotomolding, thermoforming, casting, melt extrusion and extrusion coating. High molecular weight thermoplastic polymers, for example, hydrocarbon polymers and polyamides, are melt extruded into shaped structures by well-known procedures wherein a rotating screw pushes a viscous polymer melt through an extruder barrel into a die in which the polymer is shaped to the desired form, and is then subsequently cooled and solidified into a product, that is, the extrudate, having the general shape of the die. Inorganic powders may be added to the polymers. In particular, titanium dioxide pigments, have been added to polymers for imparting whiteness and/or opacity to the finished article.

Certain plastics such as acrylic, Ultem®, PVDF, and PTFE are inherently UV stable. However, most plastic materials exhibit color change and loss of elongation when exposed to UV light. Most unmodified plastics will eventually become brittle and exhibit changes in appearance when used outdoors. The ability of a plastic to resist color fading is based upon a number of factors including the UV stability of the base polymer and the UV stability of the pigment. These vary considerably from material to material. Additionally, some plastics contain UV absorbers and/or UV resistant cap layers to enhance their weatherability. Bright colors such as reds, yellows, greens and blues often contain high loadings of organic pigments and these colors are more likely to fade over time.

Due to advances in polymer technology, it is possible to modify plastics that would otherwise quickly degrade in outdoor environments with additives, coatings, and/or coextruded surfaces to extend their outdoor life. Weathering resistance of some plastics can be improved by adding UV stabilizers or UV resistant caps to protect the base polymer. These enhanced plastic materials have excellent weatherability and will often provide many years of service in outdoor applications.

For instance, US 2011/0151163 to E.I. DuPont De Nemours and Company describes polymer-based products containing inorganic powders, in the ultrafine particle size range, in combination with colorants such as color pigments, and more particularly to polymer-based products having improved solar reflectivity and UV protection. The polymer compositions comprise (a) a polymer; (b) a colorant; and (c) an ultrafine TiO₂ having a median primary particle size (MPPS) of greater than about 70 nm, more typically about 70 nm to about 135 nm and still more typically about 90 nm to about 120 nm. The polymer can be thermoplastic or thermosetting and is about 40% to about 99.8% by weight of solids and selected from the group consisting of polyolefin; polyvinyl chloride; acrylonitrile/butadiene/styrene (ABS), acrylonitrile/styrene/acrylate (ASA); polyimide; polyester; polycarbonate; polyurethane; epoxy; phenolic; and mixtures thereof. Results indicate that the level of solar reflectivity is highly dependent on mean particle size of the TiO₂ and the type of colored pigment.

U.S. Pat. No. 9,522,304 describes polyamide golf ball compositions that may contain ultraviolet light absorbers and stabilizers. The golf balls can contain a trademark, symbol or logo using pad-printing, ink-jet printing, or dye-sublimation.

WO 2017/029578 discloses nylon composite resins having polymer-based color masterbatch and glass fiber filler, which may contain UV absorbers at 0.1 wt. % to 3.0 wt. % of the resin composite.

There is a desire to develop polymers that are specifically adapted for sublimation printing. Specifically, there is a desire to produce enhanced plastic materials that can be sublimated and that have excellent weatherability and will provide many years of service in outdoor applications. In particular, there is a desire to produce sublimated plastics that maintain visual appearance after natural weathering or an accelerated weathering test, such as ISO 16474-2:2013.

### SUMMARY OF THE INVENTION

In accordance with the foregoing, the present invention provides a polymer composition suitable for sublimation. The composition comprises about 60-90% by weight of polymer selected from the group consisting of polyamides, polyester, polyether and combinations thereof; UV absorber; UV inhibitor; pigment; and antioxidant.

In certain embodiments, the polymer composition comprises about 0.1-10% UV absorber.

In some embodiments, the polymer composition comprises about 0.1-10% UV inhibitor.

In certain embodiments, the antioxidant is present at about 0.1-10% by weight of the composition.

In some embodiments, the pigment is present at about 0.1-20% by weight of the composition.

In certain preferred embodiments, the polymer consists of polyamide. In some of those embodiments, polymer is selected from the group consisting of nylon 6, nylon 6,6, nylon 6,10, nylon 11, and nylon 12. In certain preferred embodiments, the polyamide consists essentially of nylon 6,6.

In some preferred embodiments the invention includes a polymer composition for improved sublimation comprising about 60-90% by weight of at least one polyamide selected from the group consisting of nylon 6, nylon 6,6, nylon 6,10, nylon 11, and nylon 12 and combinations thereof; about 0.1-10% UV absorber; about 0.1-10% UV inhibitor; about 0.1 to 20% pigment; and about 0.1 to 10% by weight antioxidant. In some of those embodiments, the polyamide consists essentially of nylon 6,6.

The invention also includes sublimated polymer compositions comprising a substrate containing about 60-90% by weight of polymer selected from the group consisting of polyamides, polyester, polyether and combinations thereof, UV absorber; UV inhibitor; pigment, and antioxidant; and a coating applied to the substrate by a sublimation process.

In certain embodiments, the coating is a powder that cures at from 20×160° C. to 20×200° C.

In some embodiments, the substrate comprises about 0.1-10% by weight of UV absorber. In some of those embodiments, the substrate comprises about 0.5% to about 7.5%, more preferably about 2.0% to about 5.0% by weight of UV absorber.

In certain embodiments, the substrate comprises about 0.1-10% by weight of UV inhibitor, more preferably 0.5% to about 7.5%. In some embodiments, the UV inhibitor is about 2.0% to about 5.0% by weight.

In some embodiments, the substrate comprises about 0.1-30% by weight pigment, more preferably 10.0-30.0%, most preferably 15.0-25.0% by weight pigment.

In certain embodiments, the coating is digitally printed onto the substrate. In other embodiments, the coating is rotogravure printed onto the substrate. In yet other embodiments, the coating is plotter printed onto the substrate.

In certain advantageous embodiments, the sublimated composition exhibits greater resistance to weathering after 200 hours of exposure in accordance with ISO 16474-2:2013 than a composition without UV absorber.

In some advantageous embodiments, the sublimated composition exhibits greater resistance to weathering after 600 hours of exposure in accordance with ISO 16474-2:2013 than a composition without UV absorber.

The invention further includes pellets and melt-extruded products prepared from the inventive polymer compositions.

### BRIEF DESCRIPTION OF THE DRAWINGS

FIG. 1 is a sublimated polymer article in accordance with the invention.

FIG. 2 shows comparative results of product produced in accordance with and without the invention after exposure to an accelerated weathering test.

FIG. 3 shows comparative results of product produced in accordance with and without the invention after exposure to an accelerated weathering test.

The patent or application file contains at least one drawing executed in color. Copies of this patent or patent application publication with color drawing(s) will be provided by the Office upon request and payment of the necessary fee.

### DETAILED DESCRIPTION OF THE INVENTION

Sublimated polymer-based products prepared from polyamide, polyester or polyether polymer compositions containing UV absorber show improvement in weatherability. The inventor has found that compositions comprising about 60-90% by weight of polymer selected from the group consisting of polyamides, polyester, polyether and combinations thereof; UV absorber; UV inhibitor; pigment, and antioxidant, which may be formed into plastic pellets or other products for sublimation, have increased resistance to weathering compared to prior polymer compositions.

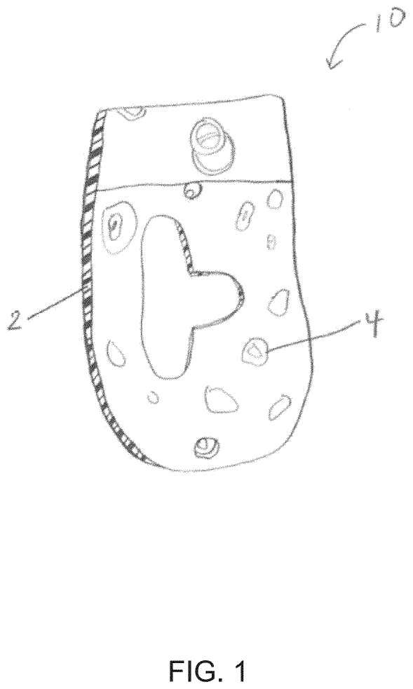

FIG. 1 shows a sublimated plastic automatic gear of a car 10 in accordance with the invention. The gear 10 comprises a polymer-based substrate 2 to which a patterned design 4 has been applied by a sublimation printing process. The substrate 2 is comprised of thermoplastic polymer, UV absorber, UV inhibitor, pigment, and antioxidant.

Polymer:

The term, “polymer” refers to, but is not limited to, oligomers, homopolymers, copolymers, terpolymers, and the like.

The polymer may be thermoplastic. In one embodiment the thermoplastic polymer may be a melt-processable polymer which may be employed together with the UV absorbers, UV inhibitors, pigments and antioxidants of this disclosure. Typically the polymer is a high molecular weight polymer and is thermoplastic. “High molecular weight” is meant to describe polymers having a melt index value of about 0.01 to about 50, typically from about 2 to about 10 as measured by ASTM method D1238-98. By “melt-processable,” it is meant a polymer that can be extruded, molded, laminated or otherwise converted into shaped articles through a stage that involves obtaining the polymer in a molten state.

The polymer must be able to withstand temperatures above 170-180° C., typically greater than 200° C., in a sublimation process, or adaptable to withstand such temperatures by incorporation with additional ingredients.

In another embodiment, the polymer is thermosetting. Thermosetting resins are those which change irreversibly due to heat or or catalyst from a fusible and or soluble material into one which is infusible and insoluble through the formation of a covalently cross linked, thermally stable network. Typical thermosetting resins include epoxy, phenolic, amino, unsaturated polyester and urethanes.

Polymers which are preferred for use in this disclosure include, by way of example but not limited thereto, are polymers of the polyamide family, polyester family and polyether family.

In general, polyamides refer to high molecular weight polymers in which amide linkages (—CONH—) occur along the length of the molecular chain. Suitable polyamides for use in the compositions of this invention may be obtained, for example, by: (1) polycondensation of (a) a dicarboxylic acid, such as oxalic acid, adipic acid, sebacic acid, terephthalic acid, isophthalic acid or 1,4-cyclohexanedicarboxylic acid, with (b) a diamine, such as ethylenediamine, tetramethylenediamine, pentamethylenediamine, hexamethylenediamine, or decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononanoic acid, 11-aminoundecanoic acid or 12-aminododecanoic acid; or (4) copolymerization of a cyclic lactam with a dicarboxylic acid and a diamine.

The polymers may have various structures including, but not limited to, regular, irregular, alternating, periodic, random, block, graft, linear, branched, isotactic, syndiotactic, atactic, and the like.

Polyamide polymers include, but are not limited to, polyamide copolymers (copolyamides) having two types of monomers, copolymers having three types of monomers, and copolymers having more than three types of monomers. Blends and alloys of polyamides also may be made in accordance with this invention as described further below. Specific examples of suitable polyamides include, but are not limited to, nylon 6, nylon 6,6; nylon 6,10; nylon 11, and nylon 12. Aliphatic and aromatic polyamides and blends thereof may be prepared in accordance with this invention. In certain preferred embodiments, the polyamide may be nylon 6,6. Different commercially-available nylon resins may be used in accordance with the present invention including, but not limited to polyammide 6.6 resins available from Ascend Performance Materials and LG Chem LTD, Plastamid®, Trimid® and Polyram® nylon 6,6 and nylon 6 resins, available from Polymer Technology & Services, LLC; Technyl® nylon 6,6 and nylon 6 resins, available from Rhodia Engineering Plastics; Ultramid® and Capron® nylon 6 resins, available from BASF; Cristamid® and Rilsan® nylon resins, available from Arkema Inc; Vestamid® nylon resins, available from Evonik Industries; Zytel® and Elvamide® nylon resins, available from the DuPont Company; and Grivory® GTR 45 and Grilamid® TR-90, transparent nylon resins, available from Grilamid® EMS.

Another example of a group of suitable polyamides is thermoplastic polyamide elastomers. Thermoplastic polyamide elastomers typically are copolymers of a polyamide and polyester or polyether. For example, the thermoplastic polyamide elastomer can contain a polyamide (for example, nylon 6, nylon 6,6; nylon 11, nylon 12 and the like) as a hard segment and a polyether or polyester as a soft segment.

Polyesters refers to polymers that contain a plurality of ester linkages. The most commonly used polyester is polyethylene terephthalate (PET). Other commonly used polyesters include polybutylene terephthalate (PBT), polybutylene succinate (PBS), polyethylene adipate (PEA), polycaprolactone (PCL), and polylactic acid (PLA). Different commercially-available polyester resins may be used in accordance with the present invention.

Polyethers refers to a group of compounds containing a comprehensive monol having an ether bond, and polyols and derivatives thereof. Different commercially-available polyether resins may be used in accordance with the present invention.

In particular embodiments, the polymer may be selected from the group consisting of Polyammide 66=PA 66, Polyammide 6=PA 6, Polyammide 6 10=PA 610, Polyammide 11=PA 11 and Polyammide 12=PA 12. Alternatively, the polymer may be selected from the group consisting of Polybutilentereftalato=PBT and Polyetilentereftalato=PET. In certain embodiments, the polymer may be selected from the group consisting of Polyetersolfone=PSO, Polysulfone=PSU and Polyfenil oxide=PPO. Mixtures of polymers are also contemplated.

Different rheological modifiers may be included in the polymer at about 10% to about 30% by weight, more preferably 15% to 25% by weight, most preferably at around 20% by weight. As one non limiting example polyamide 6 may be used to modify polyamide 6,6 polymer.

The polymer is present in the amount of about 60% to 99% by weight, more preferably about 60% to about 90% by weight of the composition, based on the total weight of solids. In some embodiments, the polymer is present in the amount of about 80%±20. Most preferably, the polymer is present in the amount of about 80%.

Pigment:

Any conventional colorant such as a pigment, dye or a dispersed dye may be used in this disclosure to impart color to the polymer-based product wherein the pigment is resistant to temperatures greater than or equal to 170° C. In one embodiment, generally, about 0.1% to about 30% by weight of conventional pigments, based on the total weight of the component solids, can be added. More typically, about 10% to about 30% by weight of conventional pigments, based on the total weight of component solids, can be added. Most typically, about 20% by weight of conventional pigments, based on the total weight of component solids, can be added. Conventional compounding techniques such as Banbury, twin screw, or continuous mixer may be used to disperse the pigments to form a compound or concentrate. The compound or concentrate may then be blended with additional constituents of the polymer-based product in order to form the final product.

The pigment component of this disclosure may be any of the generally well-known pigments or mixtures thereof used in polymer-based products wherein the pigment is resistant to temperatures greater than or equal to 170° C. Some suitable examples may be found in Chapter IV, Volume I Powder Coatings, The Technology, Formulation and Application of Powder Coatings by David M Howell (2000), Special Effect Pigments by Gerhard Pfaff (2008), and Metallic Effect Pigments by Peter Wissling (2006). Any of the commercial pigments used in polymer-based products can be utilized in these compositions such as the following: metallic oxides, such as titanium dioxide, zinc oxide, aluminum oxide, and iron oxide, metal hydroxide, metal flakes, such as aluminum flake, chromates, such as lead chromate, sulfides, sulfates, carbonates, carbon black, silica, talc, china clay, phthalocyanine blues and greens, organo reds, organo maroons, pearlescent pigments and other organic pigments and dyes. If desired chromate-free pigments, such as barium metaborate, zinc phosphate, aluminum triphosphate and mixtures thereof, can also be used.

Some useful pigments include C.I. Pigments: Black 12, Black 26, Black 28, Black 30, Blue 15.0, Blue 15.3 (G), Blue 15.3 (R), Blue 28, Blue 36, Blue 385, Brown 24, Brown 29, Brown 33, Brown 10P850, Green 7 (Y), Green 7 (B), Green 17, Green 26, Green 50, Violet 14, Violet 16, Yellow 1, Yellow 3, Yellow 12, Yellow 13, Yellow 14, Yellow 17, Yellow 62, Yellow 74, Yellow 83, Yellow 164, Yellow 53, Red 2, Red 3 (Y), Red 3 (B), Red 4, Red 48.1, Red 48.2, Red 48.3, Red 48.4, Red 52.2, Red 49.1, Red 53.1, Red 57.1 (Y), Red 57.1 (B), Red 112, Red 146, Red 170 (FSRK Type) Bluer, C.I. Pigment Orange 5, Pigment Orange 13, Pigment Orange 34, Pigment Orange 23 (R), and Pigment Orange 23 (B). Some useful organic pigments include: Pigment Yellow 151, Pigment Yellow 154, Pigment Yellow 155, Pigment Red 8, Pigment Red 8, Pigment Red 49.2, Pigment Red 81, Pigment Red 169, Pigment Blue 1, Pigment Violet 1, Pigment Violet 3, Pigment Violet 27, Pigment Red 122, Pigment Violet 19. Some useful inorganic pigments include: Middle Chrome, Lemon Chrome, Prime-Rose Chrome, Scarlet Chrome, and Zinc Chromate.

More typical pigments include: Black 12, Black 26, Black 28, Black 30, Blue 28, Blue 36, Blue 385, Brown 24, Brown 29, Brown 33, Green 17, Green 26, Green 50, Violet 14, Violet 16, Yellow 164 and Yellow 53.

Suitable preferred pigments may be commercially obtained from BASF, Clarian and Allnex.

UV Inhibitor:

Suitable UV inhibitors include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers.

These types of ingredients may also be obtained from BASF, Clarian and Allnex.

UV inhibitors are generally used in amounts of 0.1 wt. % to 10.0 wt. %, or about [insert narrower range] wt. %, of the polymer composition, but could be used in other amounts.

UV Absorber:

Suitable UV absorbers include conventionally disclosed UV absorbers, for example, hydroxybenzophenones; hydroxybenzotriazoles; hydroxybenzotriazines; cyanoacrylates; oxanilides; benzoxazinones; 2-(2H-benzotriazol-2-yl)-4-(I,I,3,3-tetramethylbutyl)-phenol (CYASORBT™ 5411); 2-hydroxy-4-n-octyloxybenzophenone (CYASORB™ 531); 2-[4,6-bis(2,4-dimethylphenyl)-I,3,5-triazin-2-yl]-5-(octyloxy)-phenol (CYASORB™ 1164); 2,2′-(I,4-phenylene)bis(4H-3,I-benzoxazin-4-one) (CYASORB™ UV-3638); I,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(I,4-phenylene)bis(4H-3,I-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers.

Suitable UV absorbers further includes hindered amine light stabilizers (HALS) or the like, or combinations including at least one of the foregoing conventional UV absorbers. Blends of HALS with other UV absorbers that may be suitable are available from BASF under the Tinuvin® product line. Preferable UV absorbers may also be commercially obtained from Clarian and Allnex.

In some embodiments, the UV absorber is preferably a second generation absorber. In certain preferred embodiments the UV absorber is selected from one or more of benzotriazole, HALS, triazine and hydro phenyltriazine.

UV absorbers have been described in Powder Coatings Chemistry and Technology by Pieter Gillis de Lange (a photocopy of a relevant page is included with the IDS), which is incorporated herein by reference in its entirety.

UV absorbers are generally included in amounts of 0.1 wt. % to 10.0 wt. %, or about 0.5% to about 7.5% of the composition, more preferably about 2.0% to about 5.0% of composition.

Antioxidants:

Suitable antioxidants are conventionally known in the polymer arts and include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants.

Antioxidants preferably may also be obtained from BASF, Clarian and Allnex.

Antioxidants are generally used in amounts of 0.1 wt. % to 10 wt. %, or about 1.0 to about 7.0 wt. %, of the resin composite, but could be used in other amounts. Most preferably, antioxidant is present at about 3 wt. %.

Other Components:

Optionally, the polymer blends disclosed herein can comprise at least one additive for the purposes of improving and/or controlling the processibility, appearance, physical, chemical, and/or mechanical properties of the polymer blends. In some embodiments, the polymer blends do not comprise an additive. Any plastics additive known to a person of ordinary skill in the art may be used in the polymer blends disclosed herein. Non-limiting examples of suitable additives include slip agents, anti-blocking agents, plasticizers, fillers, lubricants, antifogging agents, flow aids, coupling agents, cross-linking agents, nucleating agents, surfactants, solvents, flame retardants, antistatic agents, oil or extender, odor absorber and combinations thereof.

Other components may be present in the polymer composition at 0-5% by weight.

Functional additives may be included in the compositions at 0-60%, more preferably 10-50%, most preferably 20-40% by weight. Non-limiting examples include antimicrobial additives, additives to lower the electrical resistance in order to improve conductability, pigments that can change colors with temperature and with different electrical tension applied and glow in the dark additive.

Preparation of Polymer Pellets

The present disclosure provides a process for preparing a polymer-based product from a powder-containing polymer composition. Typically, in this process, the composition components are weighed in the lab and mixed in a suitable container. The container is installed on a mixer to obtain perfect mixing of all components. The material is extruded so that it has a homogeneous mixture and the extruded materials are cooled. Subsequently, the cooled material is broken into pellets in a shape and size that is ideal for future use.

In one embodiment, pigment, UV inhibitor and UV absorber, and antioxidant may be contacted with a melt processable polymer. Any melt compounding techniques, known to those skilled in the art may be used. Any means of combining or blending the ingredients known to those skilled in the art may be used. Processing temperatures depend on the polymer and the blending method used, and these are well known to those skilled in the art. The intensity of mixing depends on the polymer characteristics.

The resulting polymer compositions of this disclosure are useful in production of shaped substrates. The amount of polymer, pigment, UV absorber, UV inhibitor, antioxidant and additional components present in this polymer composition and shaped polymer-based product will vary depending on the end use application.

It is preferable that the compositions are able to withstand high temperatures necessary for sublimation and pressures of 30-90 psi.

Substrates:

The polymer compositions and pellets may be used to form various substrates suitable for sublimation.

In one embodiment, a polymer-based product or shaped article such as a plastic part is typically produced by feeding an injection molding machine with pellets of the invention, and adjusting the setting of the machine as per technical data sheets of the pellets. The pellets are fused inside an injection syringe and then injected in a mold. The space of the mold is filled with the pellets and then immediately cooled down so the piece can exit the mold.

This disclosure is particularly suitable for producing articles such as windows, doors, garage doors, railing, fencing, decking, shutters, louvers, awning, thresholds, furniture for office, and patio, cabinets, bar table-chairs, lockers, doors, shelves, racks, display cabinets, signage, stanchions, trash cans, and components of bicycles, motorcycles, cars, etc.

The shaped articles are suitable for sublimation printing processes. Sublimation printing may be carried out using typical conditions/equipments used in the art. Preferably, a coating is digitally printed, rotogravure printed or plotter printed onto the polymer-based substrate.

Coating:

The coating applied to the substrate may include decorative powder coatings, transfer films and inks. Powder coatings includes polyesters, polyurethanes and epoxy. Transfer films includes film to paper or pet. Inks that may be applied in the coating include sublimation inks.

Decoral System provides turn-key sublimation equipment to OEMs, extruders, and powder coating facilities throughout the world. Products are initially powder coated (or liquid painted). A transfer film, printed with special inks, is applied over the products under vacuum for a tight contact. Products are then loaded into a decoration machine at high temperature that turns inks into a gas that penetrates deep into the coated layer. Products are then taken out of the decoration machine and the used films are peeled off to reveal the images. At this point the products are completely decorated and ready for shipment. No additional protection coatings are required.

The coating may take the form of various patterns. For instance a wide range of wood grain, marble, granite and fantasy patterns may be applied during the sublimation printing.

The sublimated substrates are advantageously Anti-Graffiti, Anti-Slip, Anti-Microbial, Anti-Scratch, Super-Durable (UV resistant) and TGIC free (non-toxic).

Accelerated weathering tests including ISO 16474-2:2013, ASTM D2565, ASTM D4459, ASTM DG155, ISO 4892, and SAE J1885 use Xenon arc exposure to assess how a plastic will perform outdoors. Although these tests provide useful information, they do not precisely predict with how long a plastic part will last in an outdoor environment. A typical guideline is that it takes 1500 hours of xenon arc exposure to achieve the same amount of radiation as 12 months of outdoor use in Florida.

Sublimated articles produced in accordance with the invention exhibit greater resistance to weathering after 200 and 600 hours of exposure in accordance with ISO 16474-2:2013 than product that does not employ the inventive polymer compositions and are expected to produce superior results when subjected to alternative weathering tests. The content of ISO 16474-2:2013 is incorporated herein by reference.

The examples which follow are not intended to limit the scope of the disclosure. Various modifications, alternative constructions and equivalents may be employed without departing from the true spirit and scope of the invention.

### EXAMPLES

### Example 1

### Formulation of Sublimation Polymer

FORMULATION SUBLIMATION POLYMER

| Description of components | Quantity | Range |
|---|---|---|
| Nylon polymer | 80 | ±20 |
| Rheologic Polymer Modifier | 20 | ±10 |
| Various Functional Additives | 30 | ±30 |
| Phenolic base | 1.5 | ±1 |
| Phosfit/diphosfit base (Antioxidant) | 1.5 | ±1 |
| UV absorber 1 | 1.8 | ±1 |
| UV absorber 2 | 1.8 | ±1 |
| UV absorber 3 | 0.5 | ±0.3 |
| UV absorber 4 | 0.5 | ±0.3 |
| Other various pigments resistant t >250° C. | 20 | ±10 |

### Example 2

### Comparative Study

Objective: Study and evaluation of “Decoral System plastic polymer”.

Sample Specification:

| ID | Type of Sample | Sublimation Film | Exposure Time |
|---|---|---|---|
| 1 | w/o UV absorber | 6007/01 | 600 hours |
| 2 | With UV absorber | 6007/01 | 600 hours |
| 3 | w/o UV absorber | Film by Plotter | 200 hours |
| 4 | With UV absorber | Film by Plotter | 200 hours |

Testing Machine: Qsun 3000, Reference method: ISO 16474-2 with a dry cycle of 102 minutes and a wet cycle of 18 minutes (550 W/m2 290-800 nm) until the end of the test. Visual evaluation was conducted before and after test due to unusual shape of the samples.

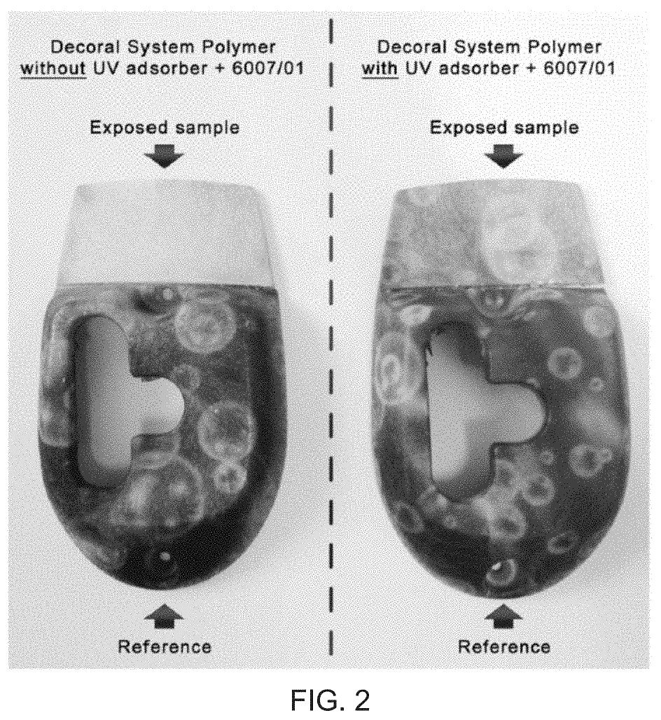

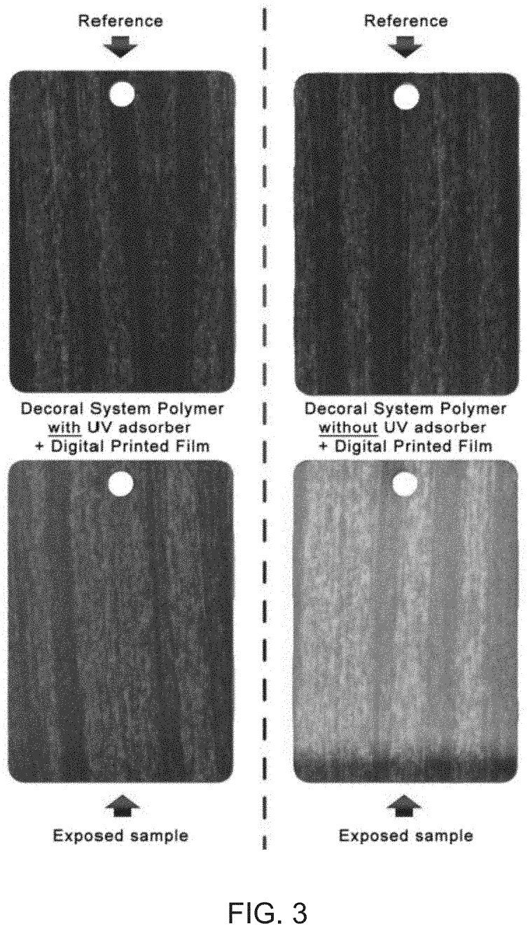

Results: FIG. 2 shows results of sample ID 1 on left and sample ID 2 on right. Exposed sample is shown on the top and reference samples are shown on the bottom. FIG. 3 shows results of sample ID 4 on the left and sample ID 3 on the right. Reference product is shown on top and exposed sample is shown on the bottom.

Observations: the “Decoral System plastic polymer”, with and without UV absorber, can receive sublimation ink from rotogravure printing (6007/01 film) and also from plotter printing; if UV absorber is used, improved resistance of sample and protection of the sublimation ink was observed. It is understood that the UV absorber may also be referred to as a UV inhibitor.

It is understood that the compositions and products described and illustrated herein represent only some embodiments of the invention. It is appreciated by those skilled in the art that various changes and additions can be made to compositions and products without departing from the spirit and scope of this invention. It is intended that all such embodiments be covered by the appended claims.

What is claimed is:

1. A sublimated polymer composition comprising:
a substrate comprising about 60-90% by weight of polymer selected from the group consisting of polyamides, polyester, polyether and combinations thereof;
UV absorber;
UV inhibitor;
pigment;
antioxidant; and
a sublimated design applied to the substrate by a sublimation process;
wherein the pigment is a compound that is different from at least one of the UV absorber and the UV inhibitor.

2. The sublimated polymer composition of claim 1, wherein the composition comprises about 0.1-10% UV absorber.

3. The sublimated polymer composition of claim 1, wherein the composition comprises about 0.1-10% UV inhibitor.

4. The sublimated polymer composition of claim 1, wherein the antioxidant is present at about 0.1-10% by weight of the composition.

5. The sublimated polymer composition of claim 1, wherein the pigment is present at about 10-30% by weight of the composition.

6. The sublimated polymer composition of claim 1, wherein the polymer consists of polyamide.

7. The sublimated polymer composition of claim 6, wherein the polyamide is selected from the group consisting of nylon 6, nylon 6,6, nylon 6,10, nylon 11, and nylon 12.

8. The sublimated polymer composition of claim 1, wherein the sublimated design is digitally printed onto the substrate.

9. The sublimated polymer composition of claim 1, wherein the sublimated design is rotogravure printed onto the substrate.

10. The sublimated polymer composition of claim 1, wherein the sublimated design is plotter printed onto the substrate.

11. The sublimated polymer composition of claim 1, wherein the sublimated composition exhibits greater resistance to weathering after 200 hours of exposure in accordance with ISO 16474-2:2013.

12. The sublimated polymer composition of claim 1, wherein the sublimated composition exhibits greater resistance to weathering after 600 hours of exposure in accordance with ISO 16474-2:2013.

13. A pellet prepared from the composition of claim 1.

14. A melt-extruded product prepared from the composition of claim 1.

15. A sublimated polymer composition for improved sublimation comprising
a substrate comprising about 60-90% by weight of at least one polyamide selected from the group consisting of nylon 6, nylon 6,6, nylon 6,10, nylon 11, nylon 12 and combinations thereof;
about 0.1-10% organic UV absorber;
about 0.1-10% organic UV inhibitor;
about 10 to 30% pigment;
about 0.1 to 10% by weight antioxidant; and
a sublimated design applied to the substrate by a sublimation process.

16. The sublimated polymer composition of claim 15, wherein the polyamide consists essentially of nylon 6,6.

17. The sublimated polymer composition of claim 15, wherein the UV absorber is selected from the group consisting of hindered amine light stabilizers, hydroxybenzophenones, hydroxybenzotriazoles, hydroxybenzotriazines, cyanoacrylates, oxanilides, benzoxazinones, benzotriazoles, triazines, and combinations thereof.

18. The sublimated polymer composition of claim 15, wherein the UV inhibitor comprises one or more benzotriazoles.

19. The sublimated polymer composition of claim 15, wherein the pigment is a non-white pigment.
